(19) United States
(12) Patent Application Publication
(10) Pub. No.: US 2026/0057615 A1
(43) Pub. Date: Feb. 26, 2026

(54) Scalable Three-Dimensional (3D) Generation With Auto-Regressive Transformers

(71) Applicant: Roblox Corporation, San Mateo, CA (US)

(72) Inventors: Tinghui ZHOU, Castro Valley, CA (US); Kangle DENG, Pittsburgh, PA (US); Yiheng ZHU, San Mateo, CA (US); Maneesh AGRAWALA, San Mateo, CA (US); Kiran BHAT, San Francisco, CA (US); Hsueh-Ti Derek LIU, San Francisco, CA (US); Xiaoxia SUN, San Mateo, CA (US); Alexander B. WEISS, Pleasanton, CA (US); Alejandro PELAEZ, San Mateo, CA (US)

(73) Assignee: Roblox Corporation, San Mateo, CA (US)

(21) Appl. No.: 19/307,867

(22) Filed: Aug. 22, 2025

Related U.S. Application Data
(60) Provisional application No. 63/686,399, filed on Aug. 23, 2024.

(51) Int. Cl. G06T 17/20

(52) U.S. Cl. CPC G06T 17/20

(57) ABSTRACT

Various implementations relate to methods, systems, and non-transitory computer-readable media for autoregressive shape generation. In some implementations, a computer-implemented method includes obtaining an input mesh corresponding to a three-dimensional (3D) object. The computer-implemented method further includes partitioning the input mesh into a plurality of 3D cells. Each of the plurality of 3D cells may correspond to a respective root node of a plurality of root nodes of a tree structure. The computer-implemented method further includes, for each of the plurality of 3D cells, generating a respective first variable-length latent value that is a function of a surface complexity of a shape located in a corresponding 3D cell.

### CROSS-REFERENCE TO RELATED APPLICATIONS

This application is a non-provisional application that claims priority under 35 U.S.C. § 119(e) to U.S. Provisional Patent Application No. 63/686,399, filed on Aug. 23, 2024, the contents of which are hereby incorporated by reference herein in their entirety.

### TECHNICAL FIELD

Embodiments relate generally to online virtual experience platforms, and more particularly, to methods, systems, and computer readable media for scalable three-dimensional (3D) shape generation with auto-regressive transformers.

### BACKGROUND

Online platforms, such as virtual experience platforms and online gaming platforms, can include various three-dimensional (3D) objects. In some platforms, 3D objects are represented using a 3D mesh and an associated texture.

Generative artificial intelligence models enable 3D content generation for diverse applications, including shape generation, text-to-3D generation, text-driven mesh texturing, single-image 3D generation, and 3D scene editing.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

According to one aspect of the present disclosure, a computer-implemented method for autoregressive shape generation is provided. The computer-implemented method includes obtaining, by a processor, an input mesh corresponding to a three-dimensional (3D) object. The computer-implemented method includes partitioning, by the processor, the input mesh into a plurality of 3D cells. Each of the plurality of 3D cells may correspond to a respective root node of a plurality of root nodes of a tree structure. The computer-implemented method includes, for each of the plurality of 3D cells, generating, by the processor, a respective first variable-length latent value that is a function of a surface complexity of a shape located in a corresponding 3D cell.

In some implementations, for each of the plurality of 3D cells, generating the respective first variable-length latent value that is the function of the surface complexity of the shape located in the corresponding 3D cell may include, in response to a 3D cell of the plurality of 3D cells containing at least one surface point of the input mesh, computing, by the processor, a quadric-error metric associated with a local geometry corresponding to the at least one surface point included in the 3D cell. In some implementations, for each of the plurality of 3D cells, generating the respective first variable-length latent value that is the function of the surface complexity of the shape located in the corresponding 3D cell may include, in response to a 3D cell of the plurality of 3D cells containing at least one surface point of the input mesh, determining, by the processor, whether a complexity of the local geometry meets a complexity threshold based on the quadric-error metric. In some implementations, for each of the plurality of 3D cells, generating the respective first variable-length latent value that is the function of the surface complexity of the shape located in the corresponding 3D cell may include, in response to a 3D cell of the plurality of 3D cells containing at least one surface point of the input mesh, and in response to the complexity of the local geometry meeting the complexity threshold, recursively partitioning, by the processor, the 3D cell into a plurality of subdivisions that each respectively include a corresponding subset of the at least one surface point until a maximum partitioning depth has been reached to obtain the tree structure. In some implementations, each of the plurality of subdivisions correspond to a respective child node of a plurality of child nodes of the tree structure. In some implementations, for each of the plurality of 3D cells, generating the respective first variable-length latent value that is the function of the surface complexity of the shape located in the corresponding 3D cell may include, in response to a 3D cell of the plurality of 3D cells containing at least one surface point of the input mesh, generating, by the processor, the first variable-length latent value for the 3D cell based on the recursive partitioning.

In some implementations, for each of the plurality of 3D cells, generating the respective first variable-length latent value that is the function of the surface complexity of the shape located in the corresponding 3D cell includes determining, by the processor, whether the 3D cell contains the at least one surface point of the input mesh.

In some implementations, the computer-implemented method includes, for each leaf node of a plurality of leaf nodes in the tree structure, performing, by the processor, a first cross-attention operation and a first local-attention operation based on at least one first variable-length latent value associated with the leaf node to obtain a corresponding first latent vector. In some implementations, the plurality of leaf nodes correspond to bottom-most child nodes of the plurality of child nodes in the tree structure. In some implementations, the computer-implemented method includes, for each non-leaf node of a plurality of non-leaf nodes in the tree structure, averaging, by the processor, a plurality of first latent vectors each respectively corresponding to a child node of one or more child nodes associated with the non-leaf node to obtain a corresponding second latent vector. In some implementations, the plurality of non-leaf nodes include nodes in the tree structure other than the bottom-most child nodes. In some implementations, the computer-implemented method includes, for each root-child node family in the tree structure, performing, by the processor, a residual quantization based on a plurality of first latent vectors and a plurality of second latent vectors each respectively corresponding to a different root-child node family in the tree structure to obtain a quantized residual latent-tree structure that includes a plurality of quantized residual latent values.

In some implementations, the computer-implemented method includes, for each root-child node family in the tree structure, accumulating, by the processor, the plurality of quantized residual latent values to obtain an adaptive latent-tree structure.

In some implementations, the computer-implemented method includes, performing, by the processor, a second cross-attention operation and a second self-attention operation based on a plurality of second variable-length latent values stored in the adaptive latent-tree structure to obtain an occupancy field associated with the input mesh.

In some implementations, the computer-implemented method includes, performing, by the processor, a marching-cube operation based on the occupancy field to generate an output mesh corresponding to the 3D object.

In some implementations, the tree structure is an octree structure, a quadtree structure, or a k-dimensional tree structure.

According to another aspect of the present disclosure, a non-transitory computer-readable medium with instructions stored thereon that, when executed by one or more hardware processors, cause the one or more hardware processors to perform operations is provided. The operations include obtaining an input mesh corresponding to a 3D object. The operations include partitioning the input mesh into a plurality of 3D cells. Each of the plurality of 3D cells may correspond to a respective root node of a plurality of root nodes of a tree structure. The operations include, for each of the plurality of 3D cells, generating a respective first variable-length latent value that is a function of a surface complexity of a shape located in a corresponding 3D cell.

In some implementations, for each of the plurality of 3D cells, generating the respective first variable-length latent value that is the function of the surface complexity of the shape located in the corresponding 3D cell may include, in response to a 3D cell of the plurality of 3D cells containing at least one surface point of the input mesh, computing a quadric-error metric associated with a local geometry corresponding to the at least one surface point included in the 3D cell. In some implementations, for each of the plurality of 3D cells, generating the respective first variable-length latent value that is the function of the surface complexity of the shape located in the corresponding 3D cell may include, in response to a 3D cell of the plurality of 3D cells containing at least one surface point of the input mesh, determining whether a complexity of the local geometry meets a complexity threshold based on the quadric-error metric. In some implementations, for each of the plurality of 3D cells, generating the respective first variable-length latent value that is the function of the surface complexity of the shape located in the corresponding 3D cell may include, in response to a 3D cell of the plurality of 3D cells containing at least one surface point of the input mesh, and in response to the complexity of the local geometry meeting the complexity threshold, recursively partitioning the 3D cell into a plurality of subdivisions that each respectively include a corresponding subset of the at least one surface point until a maximum partitioning depth has been reached to obtain the tree structure. In some implementations, each of the plurality of subdivisions correspond to a respective child node of a plurality of child nodes of the tree structure. In some implementations, for each of the plurality of 3D cells, generating the respective first variable-length latent value that is the function of the surface complexity of the shape located in the corresponding 3D cell may include, in response to a 3D cell of the plurality of 3D cells containing at least one surface point of the input mesh, generating the first variable-length latent value for the 3D cell based on the recursive partitioning.

In some implementations, for each of the plurality of 3D cells, generating the respective first variable-length latent value that is the function of the surface complexity of the shape located in the corresponding 3D cell includes determining whether the 3D cell contains the at least one surface point of the input mesh.

In some implementations, the operations include, for each leaf node of a plurality of leaf nodes in the tree structure, performing a first cross-attention operation and a first local-attention operation based on at least one first variable-length latent value associated with the leaf node to obtain a corresponding first latent vector. In some implementations, the plurality of leaf nodes correspond to bottom-most child nodes of the plurality of child nodes in the tree structure. In some implementations, the operations include, for each non-leaf node of a plurality of non-leaf nodes in the tree structure, averaging a plurality of first latent vectors each respectively corresponding to a child node of one or more child nodes associated with the non-leaf node to obtain a corresponding second latent vector. In some implementations, the plurality of non-leaf nodes include nodes in the tree structure other than the bottom-most child nodes. In some implementations, the operations include, for each root-child node family in the tree structure, performing a residual quantization based on a plurality of first latent vectors and a plurality of second latent vectors each respectively corresponding to a different root-child node family in the tree structure to obtain a quantized residual latent-tree structure that includes a plurality of quantized residual latent values.

In some implementations, the operations include, for each root-child node family in the tree structure, accumulating the plurality of quantized residual latent values to obtain an adaptive latent-tree structure.

In some implementations, the operations include, performing a second cross-attention operation and a second self-attention operation based on a plurality of second variable-length latent values stored in the adaptive latent-tree structure to obtain an occupancy field associated with the input mesh.

In some implementations, the operations include, performing a marching-cube operation based on the occupancy field to generate an output mesh corresponding to the 3D object.

In some implementations, the tree structure is an octree structure, a quadtree structure, or a k-dimensional tree structure.

According to a further aspect of the present disclosure, a computing device is provided. The computing device includes one or more hardware processors. The computing device includes a non-transitory computer readable medium coupled to the one or more hardware processors, with instructions stored thereon, that when executed by the one or more hardware processors, cause the one or more hardware processors to perform operations. The operations include obtaining an input mesh corresponding to a 3D object. The operations include partitioning the input mesh into a plurality of 3D cells. Each of the plurality of 3D cells may correspond to a respective root node of a plurality of root nodes of a tree structure. The operations include, for each of the plurality of 3D cells, generating a respective first variable-length latent value that is a function of a surface complexity of a shape located in a corresponding 3D cell.

In some implementations, for each of the plurality of 3D cells, generating the respective first variable-length latent value that is the function of the surface complexity of the shape located in the corresponding 3D cell may include, in response to a 3D cell of the plurality of 3D cells containing at least one surface point of the input mesh, computing a quadric-error metric associated with a local geometry corresponding to the at least one surface point included in the 3D cell. In some implementations, for each of the plurality of 3D cells, generating the respective first variable-length latent value that is the function of the surface complexity of the shape located in the corresponding 3D cell may include, in response to a 3D cell of the plurality of 3D cells containing at least one surface point of the input mesh, determining whether a complexity of the local geometry meets a complexity threshold based on the quadric-error metric. In some implementations, for each of the plurality of 3D cells, generating the respective first variable-length latent value that is the function of the surface complexity of the shape located in the corresponding 3D cell may include, in response to a 3D cell of the plurality of 3D cells containing at least one surface point of the input mesh, and in response to the complexity of the local geometry meeting the complexity threshold, recursively partitioning the 3D cell into a plurality of subdivisions that each respectively include a corresponding subset of the at least one surface point until a maximum partitioning depth has been reached to obtain the tree structure. In some implementations, each of the plurality of subdivisions correspond to a respective child node of a plurality of child nodes of the tree structure. In some implementations, for each of the plurality of 3D cells, generating the respective first variable-length latent value that is the function of the surface complexity of the shape located in the corresponding 3D cell may include, in response to a 3D cell of the plurality of 3D cells containing at least one surface point of the input mesh, generating the first variable-length latent value for the 3D cell based on the recursive partitioning.

In some implementations, for each of the plurality of 3D cells, generating the respective first variable-length latent value that is the function of the surface complexity of the shape located in the corresponding 3D cell includes determining whether the 3D cell contains the at least one surface point of the input mesh.

In some implementations, the operations include, for each leaf node of a plurality of leaf nodes in the tree structure, performing a first cross-attention operation and a first local-attention operation based on at least one first variable-length latent value associated with the leaf node to obtain a corresponding first latent vector. In some implementations, the plurality of leaf nodes correspond to bottom-most child nodes of the plurality of child nodes in the tree structure. In some implementations, the operations include, for each non-leaf node of a plurality of non-leaf nodes in the tree structure, averaging a plurality of first latent vectors each respectively corresponding to a child node of one or more child nodes associated with the non-leaf node to obtain a corresponding second latent vector. In some implementations, the plurality of non-leaf nodes include nodes in the tree structure other than the bottom-most child nodes. In some implementations, the operations include, for each root-child node family in the tree structure, performing a residual quantization based on a plurality of first latent vectors and a plurality of second latent vectors each respectively corresponding to a different root-child node family in the tree structure to obtain a quantized residual latent-tree structure that includes a plurality of quantized residual latent values.

In some implementations, the operations include, for each root-child node family in the tree structure, accumulating the plurality of quantized residual latent values to obtain an adaptive latent-tree structure.

In some implementations, the operations include, performing a second cross-attention operation and a second self-attention operation based on a plurality of second variable-length latent values stored in the adaptive latent-tree structure to obtain an occupancy field associated with the input mesh.

In some implementations, the operations include, performing a marching-cube operation based on the occupancy field to generate an output mesh corresponding to the 3D object.

In some implementations, the tree structure is an octree structure, a quadtree structure, or a k-dimensional tree structure.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications; and all such modifications are within the scope of this disclosure.

### BRIEF DESCRIPTION OF DRAWINGS

FIG. 1 is a diagram of an example network environment, in accordance with some implementations.

FIG. 2 is a diagram of example adaptive shape-tokenization operations, in accordance with some implementations.

FIG. 3 is a diagram of example autoregressive shape-generation operations, in accordance with some implementations.

FIG. 4 depicts an example graphical representation of reconstruction quality versus latent size for different shape generation techniques, in accordance with some implementations.

FIG. 5 depicts a visual comparison of shape reconstruction with discrete latents for different shape generation techniques, in accordance with some implementations.

FIG. 6 depicts a visual comparison of shape reconstruction with continuous latents for different shape generation techniques, in accordance with some implementations.

FIG. 7 depicts a visual comparison of an ablation study on token length for different shape generation techniques, in accordance with some implementations.

FIG. 8 depicts a visual comparison of shape generation results for different shape generation techniques, in accordance with some implementations.

FIGS. 9A and 9B are a flowchart of a method of autoregressive shape generation, in accordance with some implementations.

FIG. 10 is a block diagram illustrating an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

Various embodiments are described herein in the context of 3D avatars and other 3D objects that are used in a 3D virtual experience or environment. Some implementations of the techniques described herein may be applied to various types of 3D environments, such as a virtual reality (VR) conference, a 3D session (e.g., an online lecture or other type of presentation involving 3D avatars), a virtual concert, an augmented reality (AR) session, or in other types of 3D environments/virtual 3D worlds that may include one or more users that are represented in the 3D environment by one or more 3D avatars.

Some generative models that can perform 3D content generation (including generation of 3D shapes) employ 3D-native diffusion or autoregressive models on top of 3D latents learned from large-scale datasets. The effectiveness of these models heavily depends on how well 3D shapes are represented (encoded as latent representations).

There are several challenges in obtaining effective latent representations of 3D shapes. 3D data is inherently sparse, with meaningful information concentrated primarily on surfaces rather than distributed throughout the shape's volume. 3D objects vary in geometric complexity, ranging from simple primitives to intricate structures with fine details. To achieve high-quality 3D shape generation, it is important the encoding process capture fine local details in the latent representation while preserving the geometric structure.

Some shape variational autoencoders (VAEs) encode shapes into fixed-size latent representations and fail to adapt to the inherent variations in geometric complexity within such shapes. Using these shape VAEs, objects may be encoded with identical or similar latent capacity (size of the latent representation) regardless of their scale, sparsity, or complexity, which may result in inefficient compression and degraded performance in downstream generative models.

While some approaches leverage sparse voxel representations such as octrees to account for sparsity, these approaches still subdivide any cell containing surface geometry to the finest level, which fails to adapt to shape complexity.

To overcome these and other challenges, the present disclosure provides technique(s) for tree structure-based adaptive tokenization. The present technique(s) dynamically adjust(s) the latent representation based on local geometric complexity measured by quadric error, thereby efficiently representing both simple and intricate regions with appropriate levels of detail. For instance, the technique(s) described herein generate an adaptive tree structure guided by quadric-error-based subdivision criterion and allocate(s) a shape latent vector to each 3D cell using a query-based transformer.

Building upon this tokenization (e.g., generation of variable-length shape tokens as a function of shape complexity), the present disclosure also provides a tree structure-based autoregressive generative model that effectively leverages the variable-sized representations in shape generation. As described below, in an example implementation, the present technique(s) reduce token counts by 50% compared to fixed-size approaches, while maintaining comparable visual quality. When using a similar token length, the present technique(s) produces a significant improvement in the realism of generated shapes. When used for an autoregressive generative model, the present technique(s) can create more detailed and diverse 3D shapes than other approaches.

In the following description, an octree structure is described in connection with the present technique(s). An octree is a hierarchical spatial data structure that recursively subdivides a 3D space into eight cells (e.g., octants). However, the present technique(s) are not limited thereto and may be extended to other hierarchical spatial data structures, e.g., such as a quadtree structure, a k-dimensional tree structure, etc. For instance, a quadtree is a hierarchical data structure that recursively subdivides a 3D space into four equal cells (e.g., quadrants).

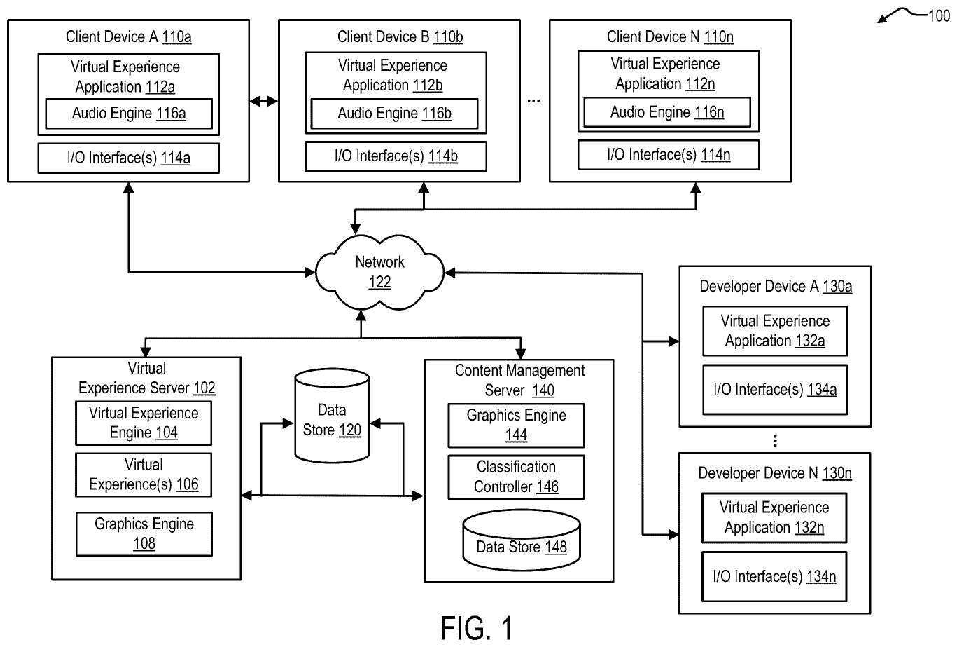

FIG. 1 is a diagram of an example system architecture 100 that includes a virtual experience platform that can support construction and presentation of 3D objects, in accordance with some implementations. In the example of FIG. 1, the 3D environment platform will be described in the context of a virtual experience platform 102 purely for purposes of explanation, and various other implementations can provide other types of 3D environment platforms, such as online meeting platforms, virtual reality (VR) or augmented reality (AR) platforms, or other types of platforms that can provide 3D content. The description provided herein for the virtual experience platform 102 and other elements of the system architecture 100 can be adapted to be operable with such other types of 3D environment platforms.

Virtual experience platforms (also referred to as “user-generated content platforms” or “user-generated content systems”) offer a variety of ways for users to interact with one another, such as while the users are playing an electronic virtual experience. For example, users of a virtual experience platform may work together towards a common goal, share various virtual gaming items, send electronic messages to one another, and so forth. Users of a virtual experience platform may play virtual experiences using characters, such as the 3D avatars, which the users can navigate through a 3D world rendered in the electronic virtual experience.

A virtual experience platform may also enable users of the platform to create and animate avatars, as well as enabling the users to create other graphical objects to place in the 3D world. For example, users of the virtual experience platform may be allowed to create, design, and customize the avatar, and to create other 3D objects for presentation in the 3D world using the technique(s) described herein.

FIG. 1 and other figures use like reference numerals to identify like elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g. “110” in the text refers to reference numerals “110a,” “110b,” and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein), virtual experience server 102, content management server 140, data store 120, client devices 110, and developer devices 130 are coupled via network 122. In some implementations, client devices 110 and developer device(s) 130 may refer to the same or same type of device.

Online virtual experience server 102 can include a virtual experience engine 104, one or more virtual experience(s) 106, and graphics engine 108. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc. The input/output devices can also include accessory devices that are connected to the client device by means of a cable (wired) or that are wirelessly connected.

Content management server 140 can include a graphics engine 144, and a classification controller 146. In some implementations, the content management server may include a plurality of servers. In some implementations, the plurality of servers may be arranged in a hierarchy, e.g., based on respective prioritization values assigned to content sources.

Graphics engine 144 may be utilized for the rendering of one or more objects, e.g., 3D objects associated with the virtual environment. Classification controller 146 may be utilized to classify assets such as 3D objects and for the detection of inauthentic digital assets, etc. Data store 148 may be utilized to store a search index, model information, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, a cloud storage system, or another type of component or device capable of storing data. The data store 120 may also include multiple storage components (e.g., multiple drives or multiple databases) that may also span multiple computing devices (e.g., multiple server computers).

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, a distributed computing system, a cloud computing system, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on client devices 110.

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., synchronous and/or asynchronous text-based communication). In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 102 may be an online gaming server. For example, the virtual experience server may provide single-player or multiplayer games to a community of users that may access or interact with games using client devices 110 via network 122. In some implementations, games (also referred to as “video game,” “online game,” or “virtual game” herein) may be two-dimensional (2D) games, three-dimensional (3D) games (e.g., 3D user-generated games), virtual reality (VR) games, or augmented reality (AR) games, for example. In some implementations, users may participate in gameplay with other users. In some implementations, a game may be played in real-time with other users of the game.

In some implementations, gameplay may refer to the interaction of one or more players using client devices (e.g., 110) within a game (e.g., game that is part of virtual experience 106) or the presentation of the interaction on a display or other output device (e.g., 114) of a client device 110.

In some implementations, a virtual experience 106 can include an electronic file that can be executed or loaded using software, firmware or hardware configured to present the game content (e.g., digital media item) to an entity. In some implementations, a virtual experience application 112 may be executed and a virtual experience 106 executed in connection with a virtual experience engine 104. In some implementations, a virtual experience 106 (e.g., a game) may have a common set of rules or common goal, and the environment of a virtual experience 106 shares the common set of rules or common goal. In some implementations, different games may have different rules or goals from one another.

In some implementations, virtual experience(s) may have one or more environments (also referred to as “gaming environments” or “virtual environments” herein) where multiple environments may be linked. An example of an environment may be a three-dimensional (3D) environment. The one or more environments of a virtual experience application 112 may be collectively referred to a “world” or “gaming world” or “virtual world” or “universe” herein. An example of a world may be a 3D world of a virtual experience 106. For example, a user may build a virtual environment that is linked to another virtual environment created by another user. A character of the virtual game may cross the virtual border to enter the adjacent virtual environment.

It may be noted that 3D environments or 3D worlds use graphics that use a three-dimensional representation of geometric data representative of game content (or at least present game content to appear as 3D content whether or not 3D representation of geometric data is used). 2D environments or 2D worlds use graphics that use two-dimensional representation of geometric data representative of game content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “game objects” or “virtual game item(s)” herein) of virtual experiences 106. For example, in generating user-generated virtual items, users may create characters, decoration for the characters, one or more virtual environments for an interactive game, or build structures used in a game. In some implementations, users may buy, sell, or trade virtual game objects, such as in-platform currency (e.g., virtual currency), with other users of the online virtual experience server 102. In some implementations, online virtual experience server 102 may transmit game content to virtual experience applications (e.g., 112). In some implementations, game content (also referred to as “content” herein) may refer to any data or software instructions (e.g., game objects, game, user information, video, images, commands, media item, etc.) associated with online virtual experience server 102 or virtual experience applications. In some implementations, game objects (e.g., also referred to as “item(s)” or “objects” or “virtual objects” or “virtual game item(s)” herein) may refer to objects that are used, created, shared or otherwise depicted in virtual experiences 106 of the online virtual experience server 102 or virtual experience applications 112 of the client devices 110. For example, game objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration, rather than limitation. In some implementations, online virtual experience server 102 may host one or more media items that can include communication messages from one user to one or more other users. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual application 112 may be associated with a particular user or a particular group of users (e.g., a private game) or made widely available to users with access to the online virtual experience server 102 (e.g., a public game). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the game (e.g., rendering commands, collision commands, physics commands, etc.) In some implementations, virtual experience applications 112 of client devices 110 may work independently, in collaboration with virtual experience engine 104 of online virtual experience server 102, or a combination of both.

In some implementations, both the online virtual experience server 102 and client devices 110 may execute a virtual experience engine and a virtual experience application (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual application 112 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual application objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on gameplay conditions. For example, if the number of users participating in gameplay of a particular virtual application 106 exceeds a threshold number, the online virtual experience server 102 may perform one or more virtual experience engine functions that were previously performed by the client devices 110.

For example, users may be playing a virtual application 112 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send gameplay instructions (e.g., position and velocity information of the characters participating in the group gameplay or commands, such as rendering commands, collision commands, etc.) to the client devices 110 based on control instructions. For instance, the online virtual experience server 102 may perform one or more logical operations (e.g., using virtual experience engine 104) on the control instructions to generate gameplay instruction(s) for the client devices 110. In other instances, online virtual experience server 102 may pass one or more or the control instructions from one client device 110 to other client devices (e.g., from client device 110a to client device 110b) participating in the virtual application 112. The client devices 110 may use the gameplay instructions and render the gameplay for presentation on the displays of client devices 110.

In some implementations, the control instructions may refer to instructions that are indicative of in-game actions of a user's character. For example, control instructions may include user input to control the in-game action, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates gameplay instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, gameplay instructions may refer to instructions that allow a client device 110 to render gameplay of a game, such as a multiplayer game. The gameplay instructions may include one or more of user input (e.g., control instructions), character position and velocity information, or commands (e.g., physics commands, rendering commands, collision commands, etc.).

In some implementations, the online virtual experience server 102 may store characters created by users in the data store 120. In some implementations, the online virtual experience server 102 maintains a character catalog and game catalog that may be presented to users. In some implementations, the game catalog includes images of virtual experiences stored on the online virtual experience server 102. In addition, a user may select a character (e.g., a character created by the user or other user) from the character catalog to participate in the chosen game. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the virtual experience platform may support three-dimensional (3D) objects that are represented by a 3D model and includes a surface representation used to draw the character or object (also known as a skin or mesh) and a hierarchical set of interconnected bones (also known as a skeleton or rig). The rig may be utilized to animate the object and to simulate motion of the object. The 3D model may be represented as a data structure, and one or more parameters of the data structure may be modified to change various properties of the character, e.g., dimensions (height, width, girth, etc.); shape; movement style; number/type of parts; proportion, etc.

In some implementations, the 3D model may include a 3D mesh. The 3D mesh may define a three-dimensional structure of the unauthenticated virtual 3D object. In some implementations, the 3D mesh may also define one or more surfaces of the 3D object. In some implementations, the 3D object may be a virtual avatar, e.g., a virtual character such as a humanoid character, an animal-character, a robot-character, etc.

In some implementations, the mesh may be received (imported) in a FBX file format. The mesh file includes data that provides dimensional data about polygons that comprise the virtual 3D object and UV map data that describes how to attach portions of texture to various polygons that comprise the 3D object. In some implementations, the 3D object may correspond to an accessory, e.g., a hat, a weapon, a piece of clothing, etc. worn by a virtual avatar or otherwise depicted with reference to a virtual avatar.

In some implementations, a platform may enable users to submit (upload) candidate 3D objects for utilization on the platform. A virtual experience development environment (developer tool) may be provided by the platform, in accordance with some implementations. The virtual experience development environment may provide a user interface that enables a developer user to design and/or create virtual experiences, e.g. games. The virtual experience development environment may be a client-based tool (e.g., downloaded and installed on a client device, and operated from the client device), a server-based tool (e.g., installed and executed at a server that is remote from the client device, and accessed and operated by the client device), or a combination of both client-based and service-based elements.

The virtual experience development environment may be operated by a developer of a virtual experience, e.g., a game developer or any other person who seeks to create a virtual experience that may be published by an online virtual experience platform and utilized by others. The user interface of the virtual experience development environment may be rendered on a display screen of a client device, e.g., such as a developer device 130 described with reference to FIG. 1, so as to enable the creator/developer to interact with the development environment using actions such as typing, highlighting, selecting, drag and drop, clicking, and so forth via a mouse, keyboard, or other input device configured to communicate with the user interface. The user interface may include a menu bar, a tool bar, a workspace pane, and a plurality of secondary panes. Depending on the particular implementation, the user interface may include alternative or additional elements, arrangements, operational features, etc. of the virtual experience development environment than what is shown and described herein.

A developer user (creator) may utilize the virtual experience development environment to create virtual experiences. As part of the development process, the developer/creator may upload various types of digital content such as object files (meshes), image files, audio files, short videos, etc., to enhance the virtual experience.

In implementations where the 3D object is an accessory, data indicative of use of the object in a virtual experience may also be received. For example, a “shoe” object may include annotations indicating that the object can be depicted as being worn on the feet of a virtual humanoid character, while a “shirt” object may include annotations that it may be depicted as being worn on the torso of a virtual humanoid character.

In some implementations, the 3D model may further include texture information associated with the 3D object. For example, texture information may indicate color and/or pattern of an outer surface of the 3D object. The texture information may enable varying degrees of transparency, reflectiveness, degrees of diffusiveness, material properties, and refractory behavior of the textures and meshes associated with the 3D object. Examples of textures include plastic, cloth, grass, a pane of light blue glass, ice, water, concrete, brick, carpet, wood, etc.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “client device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual game hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, or a gaming program) that is installed and executes local to client device 110 and allows users to interact with online virtual experience server 102. The virtual experience application may render, display, or present the content (e.g., a web page, a media viewer) to a user. In an implementation, the virtual experience application may also include an embedded media player (e.g., a Flash® player) that is embedded in a web page.

In some implementations, the virtual experience application may include an audio engine 116 that is installed on the client device, and which enables the playback of sounds on the client device. In some implementations, audio engine 116 may act cooperatively with audio engine 144 that is installed on the sound server.

According to aspects of the disclosure, the virtual experience application may be an online virtual experience server application for users to build, create, edit, and/or upload content to the online virtual experience server 102 as well as interact with online virtual experience server 102 (e.g., participate in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual game hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, or a virtual experience program) that is installed and executes local to developer device 130 and allows users to interact with online virtual experience server 102. The virtual experience application may render, display, or present the content (e.g., a web page, a media viewer) to a user. In an implementation, the virtual experience application may also include an embedded media player (e.g., a Flash® player) that is embedded in a web page.

According to aspects of the disclosure, the virtual experience application 132 may be an online virtual experience server application for users to build, create, edit, upload content to the online virtual experience server 102 as well as interact with online virtual experience server 102 (e.g., provide and/or play virtual experiences 106 hosted by online virtual experience server 102). As such, the virtual experience application may be provided to the client device(s) 130 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual applications 112 developed, hosted, or provided by a virtual experience application developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with appropriate credentials, a virtual experience application developer may obtain access to virtual experience application objects, such as in-platform currency (e.g., virtual currency), avatars, special powers, accessories, which are owned by or associated with other users.

In general, functions described in one implementation as being performed by the online virtual experience server 102 can also be performed by the client device(s) 110, or a server, in other implementations if appropriate. In addition, the functionality attributed to a particular component can be performed by different or multiple components operating together. The online virtual experience server 102 can also be accessed as a service provided to other systems or devices through appropriate application programming interfaces (APIs) and thus is not limited to use in websites.

In some implementations, online virtual experience server 102 may include a graphics engine 108. In some implementations, the graphics engine 108 may be a system, application, or module that permits the online virtual experience server 102 to provide graphics and animation capability. In some implementations, the graphics engine 108, and/or content management server 140 may perform one or more of the operations described below.

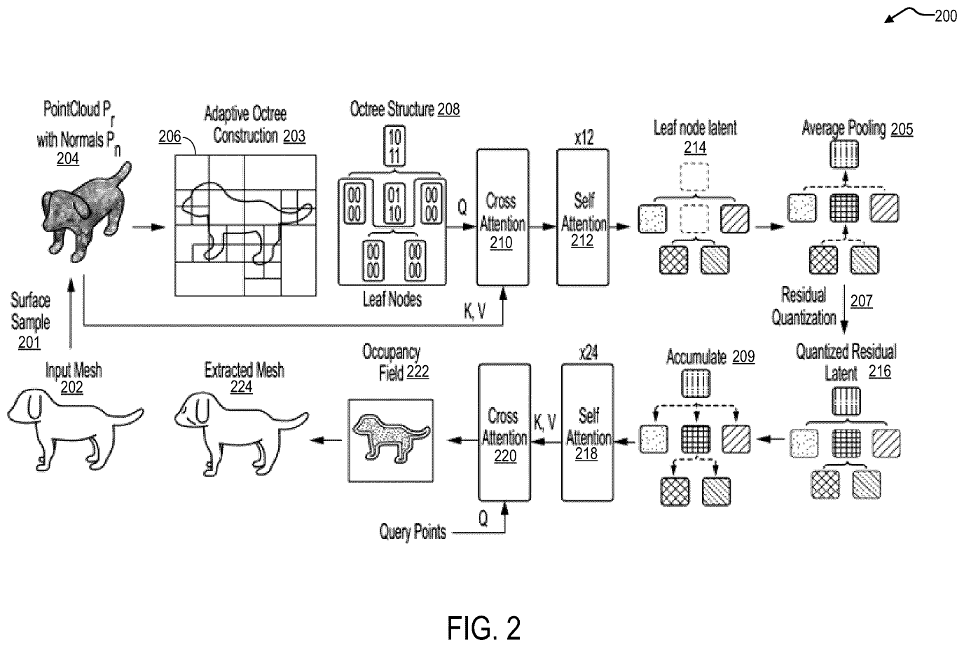

FIG. 2 is a diagram of example adaptive shape-tokenization operations 200, in accordance with some implementations.

Referring to FIG. 2, for a 3D shape, an input mesh 202 of a 3D object may be obtained by adaptive shape-tokenization system 200. Surface sampling (at 201) of the input mesh 202 may be performed to obtain a point cloud 204 (P_{c}∈ [symbol] ), along with surface normal vectors [symbol] P [symbol] ∈ [symbol] ) Then, adaptive octree construction (at 203) may be performed to partition the point cloud 204 into a plurality of 3D cells 206 based on local geometric complexity to obtain a sparse octree structure 208.

An octree is a hierarchical spatial data structure that recursively subdivides a 3D space into eight cells (e.g., octants, which may be equal cells). Starting with a root node representing a bounding cube (e.g., corresponding to one of the octants), each non-empty node can be further partitioned into eight child nodes, creating a tree-line structure O={V, E}. Cells in the octree hierarchy may be denoted as V={ν₁, ν₂, . . . }, and the parent-child node relationships may be defined according to E⊆V×V, where (ν_i, ν_j)∈E indicates that vi is the parent of νⱼ. This representation efficiently represents sparse 3D data because it allocates higher resolution (greater number of sub-divided cells) only to those cells that include at least one surface point of the point cloud 204.

A sparse octree may be generated by omitting empty child nodes, e.g., each node can have 0 to 8 child nodes, with all child nodes being non-empty. This structure may be encoded compactly by an 8-bit binary code X:V→{0, 1}⁸. For instance, X(ν)=(01001000)₂ indicates that node ν has two non-empty child nodes at its second and fifth slots. An octree structure may thus be uniquely represented as a sequence of 8-bit binary codes in breadth-first order, [X(ν₀),X(ν₁), . . . ].

The present technique(s) subdivide an octant only when the local geometry is complex. For instance, using the present technique(s), an octant may be subdivided when the local geometry of the corresponding surface points meets a complexity threshold T. A quadric-error metric may be used to measure shape complexity and guide the octree subdivision process. This approach optimizes representational capacity, allocating tokens where they provide the greatest benefit for shape fidelity.

Given a plane in [symbol] , let ρ denote a point on the plane with unit normal vector n. The plane may be defined by all points x∈ [symbol] satisfying

$${n}^{T} ( x - p ) = 0. \qquad ( 1 )$$

The quadric error measures the squared point-to-plane distance between any point x and this plane, computed as,

$$E ( x ) = {( {n}^{T} ( x - p ) )}^{2} \dot{=} [ {x}^{T} , 1 ] {Q [ {x}^{T} , 1 ]}^{T} , \qquad ( 2 )$$

where the matrix Q∈ [symbol] is defined as,

$$Q = [ \begin{matrix}{nn}^{T} & - {nn}^{T} p \\ {( - nn {T}^{} p )}^{T} & {p}^{T} {nn}^{T} p\end{matrix} ] . \qquad ( 3 )$$

The cumulative error from a point x to multiple planes may be computed with a summed quadric,

$$E ( x ) = {\sum }_{i} {E}_{i} ( x ) = [ {x}^{T} , 1 ] {( {\sum }_{i} {Q}_{i} ) [ {x}^{T} , 1 ]}^{T} . \qquad ( 4 )$$

The quadric error E*=minₓE(x)y be used to measure the geometric complexity of a cell. As the energy is quadratic, the minimum E* may be efficiently computed by solving a linear system. When the planes form common intersections (e.g., an edge, a cone, or being flat), the optimal quadric error approaches zero, whereas complex regions usually yield higher quadric error values. This property makes quadric error metrics suitable for guiding adaptive geometric representations.

For instance, for each octree cell ν∈V, the cell quadric Q_{ν} may be computed by summing the quadrics for all sampled points within ν,

$${Q}_{v} = {\sum }_{p ∈ {P}_{c} ( v )} {Q}_{p} , \qquad ( 5 )$$

where

$${P}_{c} ( v ) = \{ p ∈ {P}_{c} \vert p is contained in cell v \}$$

denotes the subset of points that lie within cell ν, and Qₚ is the quadric matrix for point ρ with its corresponding normal vector n∈Pₙ. The average quadric error

$${E}_{v}^{*}$$

can be calculated by

$${E}_{v}^{*} = {min}_{\times } {E}_{v} ( x ) = \frac{1}{\vert {P}_{c} ( v ) \vert} {min}_{x} [ {x}^{T} , 1 ] {{Q}_{v} [ {x}^{T} , 1 ]}^{T} . \qquad ( 6 )$$

Cell ν may be recursively subdivided into child cells in response to the following conditions being met: (1) the maximum depth L has not been reached, and (2) the corresponding average quadric error

$${E}_{v}^{*}$$

meets or exceeds a predetermined complexity threshold T, E*_{ν}≥T. In regions of the point cloud 204 with complex geometry, corresponding cells are subdivided to the maximum depth L, while partitioning stops early in areas with simpler (e.g., planar) geometry.

Following partitioning, a variational autoencoder (e.g., a perceiver-based VAE) may encode the shape into latents 214. The VAE (also referred to as shape encoder) may include one or more cross-attention layers 210 and one or more self-attention layers 212. For instance, the following computations may be performed:

$$\hat{P} = Concat ( PE ( {P}_{c} ) , {P}_{n} ) , \qquad ( 7 )$$

$$\hat{O} = Concat ( PE ( {V}_{l e a f} ) , SE ( {V}_{l e a f} ) ) , \qquad ( 8 )$$

$$φ ( {V}_{l e a f} ) = SelfAtt {n}^{( i )} ( CrossAttn ( \hat{O} , \hat{P} ) ) , i = 1 , … , {L}_{e} , \qquad ( 9 )$$

where \hat{P} is all points across the entire shape, Ô is the octree structure, and the encoder φ outputs a latent vector φ(ν) for every leaf cell ν∈V_{leaf}, where φ: V→

$${ℝ}^{d}$$

Here, PE denotes the positional encoding function, which may operate on point coordinates and octree cell centers, while SE denotes the scale encoding function on the depth of the octree cells. V_{leaf} may include all the leaf cells within V, and Lₑ may refer to the number of self-attention layers 212 in the shape encoder.

The cross-attention layers 210 operate on global features, allowing each leaf cell to attend to all points P across the entire shape, rather than just points within its local cell. This global attention may enable the model to capture long-range dependencies and contextual information beyond local regions. The self-attention layers 212 may further refine these representations by allowing leaf cells to exchange information.

Latent vectors may be propagated from leaf cells to ancestor cells in a bottom-up approach. A latent vector corresponding to a respective non-leaf node may be computed by averaging (average pooling) (at 205) the latent vectors of its child nodes.

An octree-based residual quantization strategy, which enables a coarse-to-fine token ordering may be performed using residual quantization (at 207). For instance, residual quantization may begin from the root node and process the residual latent of every latent from its parent to generate quantized residual latents 216. In some implementations, a shared codebook and quantization function may be used for all nodes. The residual quantization algorithm is illustrated below in Algorithm 1.

Algorithm 1 Multi-scale octree residual quantization

Input: Octree [symbol] = { [symbol] , [symbol] }, Latent ϕ : [symbol] → [symbol] .
Output: Multi-scale residual quantized latent z : [symbol] → [symbol] ,

| | Quantized latent index q : [symbol] → [symbol] . | |
|---|---|---|
| 1: | z(v₀), q(v₀) = Quantize(ø(v₀)) | [symbol] v₀ is the root node. |
| 2: | z_{acc}(v₀) = z(v₀) | [symbol] Initialize accumulated latent. |
| 3: | for d = 1, ... , L − 1 do | [symbol] L is the max depth of [symbol] . |
| 4: | for v ∈ [symbol] _{d} do | [symbol] [symbol] _{d} is the set of nodes at level d. |
| 5: | Find the parent vₚₐᵣₑₙₜ of v according to [symbol] . | |
| 6: | z(v), q(v) = Quantize(ø(v) − z_{acc} (vₚₐᵣₑₙₜ)). | |
| 7: | z_{acc} (v) = z_{acc} (vₚₐᵣₑₙₜ) + z(v). | [symbol] Update z_{acc}. |

| | |
|---|---|
| 8: | end for |
| 9: | end for |

Given the multi-scale octree residual latent z:V→ [symbol] the full latent \hat{φ}:V→ [symbol] may be computed by accumulating (at 209) the latent to every node from all its ancestors. In some implementations, a shape decoder (e.g., a perceiver-based transformer) may be used to decode the latent to an occupancy field 222. The shape decoder may include one or more self-attention layers 218 and one or more cross-attention layers 220. For instance, given a query 3D point x∈ [symbol] , the decoder may predict its occupancy value:

$$\hat{S} = Concat ( \hat{φ} ( V ) , PE ( V ) , SE ( V ) ) , \hat{S} = {SelfAttn}^{( j )} ( \hat{S} ) , j = 1 , 2 , … , {L}_{d} , \hat{σ} ( x , \hat{φ} , O ) = CrossAttn ( PE ( x ) , \hat{S} ) , \qquad ( 11 )$$

where L_{d} is the number of self-attention layers 218 in the shape decoder, and \hat{σ} is the predicted occupancy value at the query point Q. At inference time, the decoder may be queried using grid points to obtain an occupancy field 222. Marching cubes may be run on occupancy field 222 to extract an output mesh 224. During training, query points may be sampled using uniform and importance sampling near the mesh surface. The networks and codebook may be optimized via the following loss functions.

$${L}_{V Q} = {𝔼}_{v ∈} {‖ sg ( \hat{φ} ( v ) ) - φ ( v ) ‖}^{2} + {‖ sg ( φ ( v ) ) - \hat{φ} ( v ) ‖}^{2} , \qquad ( 12 )$$

where sg( ) is the stop-gradient operation. Additionally, an occupancy reconstruction loss may be used to ensure that the latent codes accurately reconstruct the input shape:

$${L}_{r e c} = {𝔼}_{X} {L}_{B C E} ( σ ( x ) , \hat{σ} ( x , \hat{φ} , O ) ) , \qquad ( 13 )$$

where L_{BCE} is the binary cross-entropy loss for shape reconstruction, and σ(x)∈{0,1} is the ground truth occupancy value of the query point, indicating whether it is located inside the object. The final loss function may be:

$${L}_{final} = {L}_{r e c} + {λ}_{V Q} {L}_{V Q} , \qquad ( 14 )$$

where λ_{VQ} weights the vector quantization loss.

By using the above Kullback-Leibler (KL) regularization, the present technique(s) learn continuous shape latents, which provides a fair comparison with other continuous latent baselines. Upon completion of training, the residual quantization (at 207), quantized residual latent (216), and accumulate (at 209) as illustrated in FIG. 2 may no longer be needed. In such implementations, KL regularization is applied on the average pooling latents (at 205).

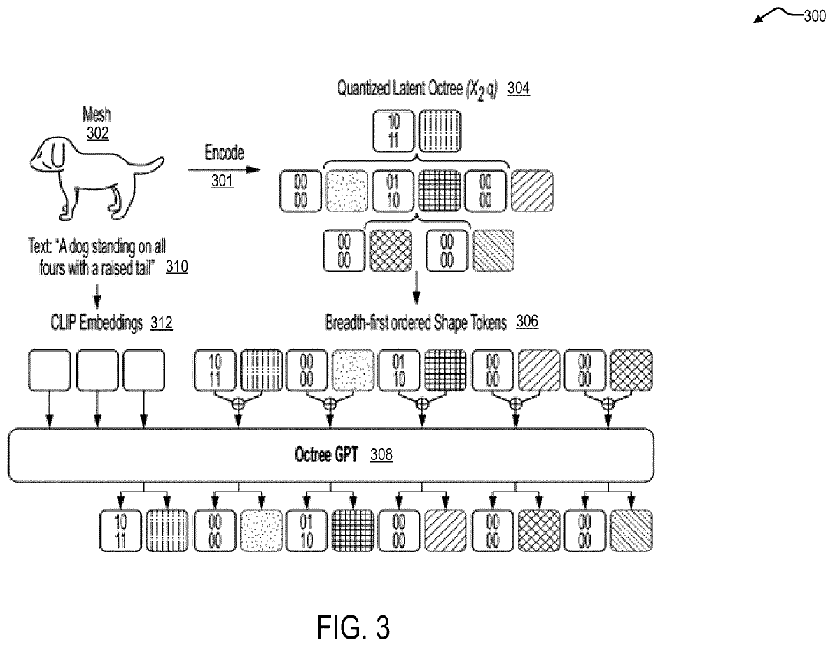

FIG. 3 is a diagram of example autoregressive shape-generation operations 300, in accordance with some implementations.

Building upon the adaptive tokenization framework described above with reference to FIG. 2, an autoregressive model (e.g., OctreeGPT 308) for generating 3D shapes conditioned on input information 310 (e.g., text, audio, picture, video, etc.) that describes or otherwise shows the 3D shape is provided. Unlike models that operate on fixed-size representations, OctreeGPT 308 models the joint distribution of variable-length octree tokens while maintaining a hierarchical coarse-to-fine structure.

A textual prompt (as input information 310), “A dog standing on all fours with a raised tail,” may be encoded (at 301) to generate an octree structure 304 (e.g., a quantized latent octree), e.g., using techniques described with reference to FIG. 2. A mesh 302 corresponding to the textual prompt is included for illustration purposes but can also be used as input in some implementations in addition to or instead of the textual prompt. In some implementations, to enable autoregressive modeling, the octree structure 304 may be serialized by traversing it in a breadth-first manner to generate breadth-first shape tokens 306. For each node (e.g., cell ν), both its quantized index q(ν)∈ [symbol] and a structural code X(ν)∈{0,1}⁸ that encodes the presence or absence of each potential child node. A latent octree may be uniquely represented by a variable-length sequence of tokens: [t₀, t₁, . . . , t_{N}], where each token tᵢ=(q(νᵢ),X(νᵢ)),∀i∈ [symbol] .

The autoregressive model may be trained to predict the next token in the sequence,

$$P ( {t}_{0} , {t}_{1} , … , {t}_{N} \vert θ ) = {\prod }_{i = 1}^{N} P ( {t}_{i} \vert {t}_{0} , … , {t}_{i - 1} \vert θ ) , \qquad ( 15 )$$

where θ is the trained model (e.g., OctreeGPT 308).

The embedding for each shape token tᵢ may be computed as:

$$Embed ( {t}_{i} ) = {Embed}_{q} ( q ( {v}_{i} ) ) + {Embed}_{X} ( X ( {v}_{i} ) ) + P {E}_{tree} ( {v}_{i} ) , \qquad ( 16 )$$

wherein X(νᵢ) is interpreted as an 8-bit integer. The tree-structured positional encoding PEₜᵣₑₑ (νᵢ) captures both spatial and hierarchical information:

$$P {E}_{f r e e} ( {v}_{i} ) = {Embed}_{x} ( x ( {v}_{i} ) ) + {Embed}_{y} ( y ( {v}_{i} ) ) + {Embed}_{z} ( z ( {v}_{i} ) ) + {Embed}_{d} ( d ( {v}_{i} ) ) , \qquad ( 17 )$$

where x, y, z are quantized coordinates of the cell center, and d∈{0, 1, . . . , L−1} is the depth of the octree node.

This multi-dimensional positional encoding may enable the model to identify spatial relationships and the hierarchical structure of the octree. In some implementations, the model may employ dual prediction heads for predicting quantized latent indices \hat{q} and structure codes \hat{X}, allowing the model to jointly identify geometry and tree structure. For text-conditioned generation (where the input is a textual prompt), the sequence may be prepended with tokens (e.g., 10 tokens, 25 tokens, 50 tokens, 77 tokens, etc.) derived from the CLIP embedding 312 (Contrastive Language-Image Pre-Training) of the input information 310 (e.g., text in the present example).

The OctreeGPT 308 may be trained using a combined loss function that balances the reconstruction of latent tokens and structural codes:

$${L}_{G P T} = {L}_{C E} ( q , \hat{q} ) + {λ}_{X} {L}_{C E} ( X , \hat{X} ) , \qquad ( 18 )$$

where L_{CE} is the cross-entropy loss for 2⁸-way classification, and λ_{X} is a balancing hyperparameter.

During inference, sampling with temperature T may be employed to control the diversity and quality of generated shapes. The predicted structural code X(νᵢ) may be processed on the fly to determine the octree topology, which dynamically establishes the final length of the token sequence.

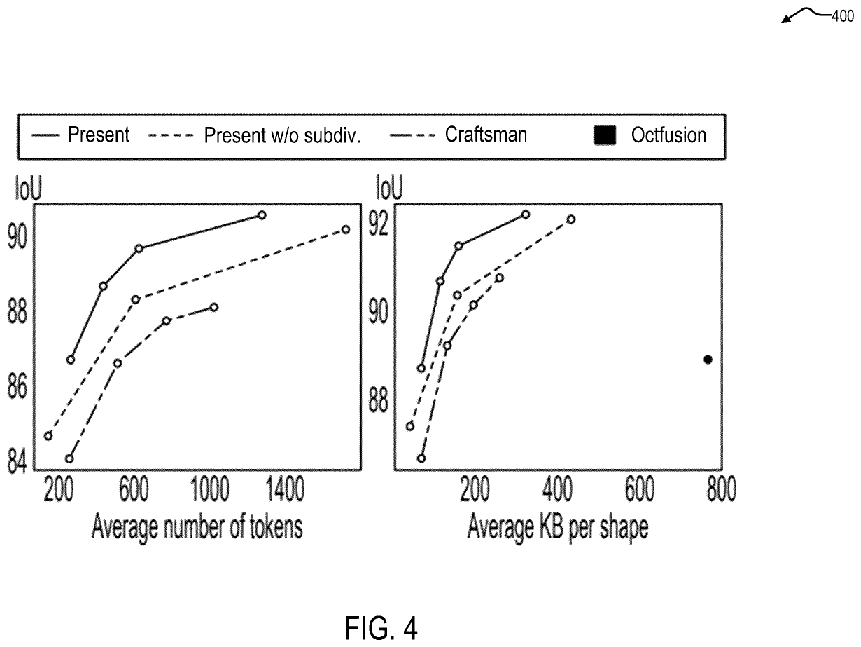

FIG. 4 is a diagram of an example graphical representation 400 of reconstruction quality versus latent size in discrete (left) and continuous (right) scenarios, in accordance with some implementations. The discrete (left) scenario shows the results of the Intersection of Union (IoU) plotted against the average number of tokens for different generation techniques. In the continuous (right) scenario, shows the results of the IoU plotted against the size in KiloBytes (KB), which is used for continuous latent representations for different generation techniques. As shown, the present technique(s) outperform baseline approaches at equivalent latent sizes and achieve a comparable reconstruction quality with approximately 50% smaller latent representations, thereby providing a lower computational cost for the same reconstruction quality.

Referring to FIG. 4, to evaluate the effectiveness of the present shape tokenization and generation technique(s), the Objaverse dataset, which contains around 800K 3D models, was used as the training and test data. To ensure high-quality training and evaluation, low-quality meshes, such as those with point clouds, thin structures, or holes, were omitted. This results in a curated dataset of around 207K objects for training and 22K objects for testing.

For preprocessing, each mesh is normalized to a unit cube. For each mesh, 1M points with their normals from the surface were sampled as the input point cloud. To generate ground-truth occupancy values, 500K points within the unit volume and an additional 1M points near the mesh surface were sampled to capture fine details and obtain the occupancy based on visibility. An adaptive octree is generated for each shape based on the sampled point cloud using a pre-defined quadric error threshold T, which guides the subdivision process according to local geometric complexity. To enable text conditioning, nine views of each object are rendered under random rotations and a model is used to generate descriptive captions from these renderings.

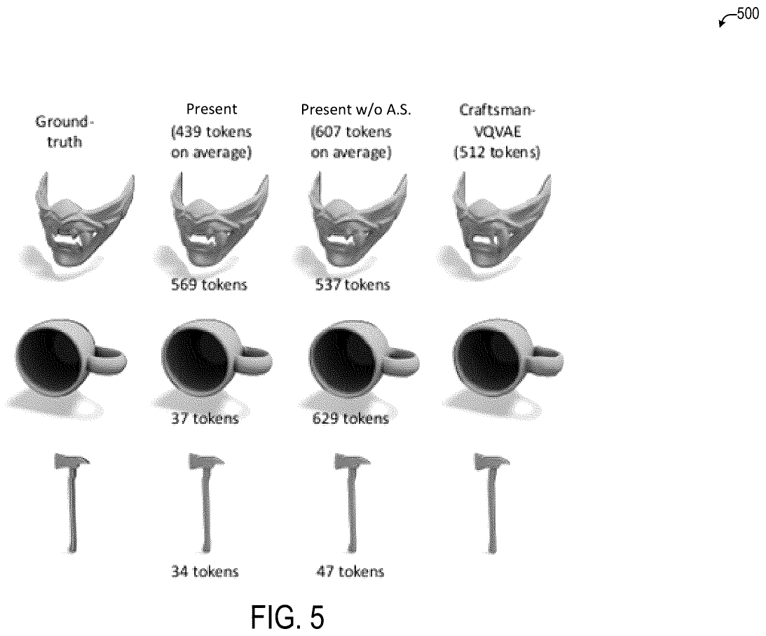

FIG. 5 depicts a visual comparison of shape reconstruction with discrete latents using various techniques, in accordance with some implementations.

Referring to FIG. 5, the present technique(s) is compared against Craftsman-VQ, as well as an ablation without Adaptive Subdivision (A.S.). Three different examples are shown in FIG. 5—mask (top row), cup (middle row), and axe (bottom row). With comparable or lower token budget, the present technique(s) outperform(s) the baseline regarding reconstruction fidelity. Meanwhile, without adaptive subdivision, the vanilla octree allocates the token budget efficiently for objects of small volume (bottom) but wastes tokens on geometrically simple objects that occupy large space (middle).

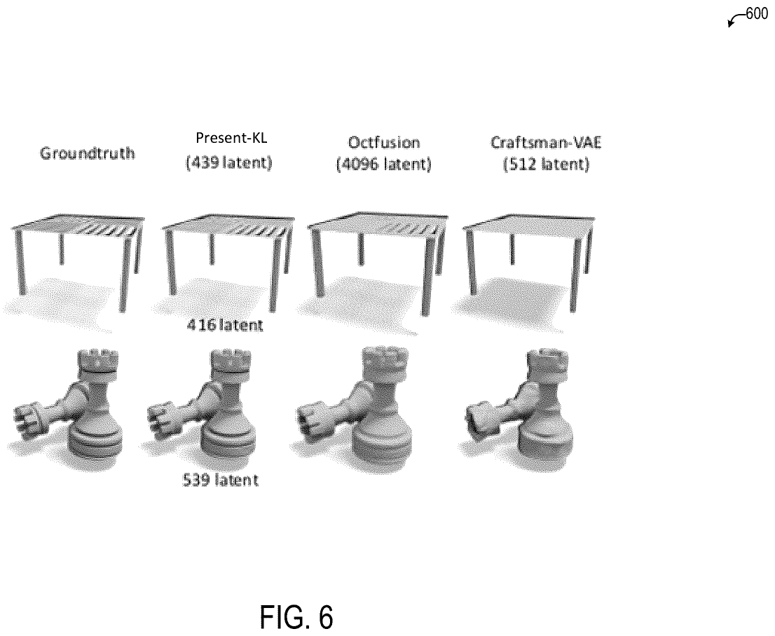

FIG. 6 depicts a visual comparison of shape reconstruction with continuous latents using various techniques, in accordance with some implementations.

Referring to FIG. 6, the visual comparison between the present techniques and other baselines is shown. In general, it can be seen that the present reconstruction technique(s) preserves more details using similar or smaller number of latent vectors. For example, for the table (top), the present method can generate a table close to the groundtruth with just 439 latents, as opposed to Octfusion (4096 latents) and Craftsman-VAE (512 latents).

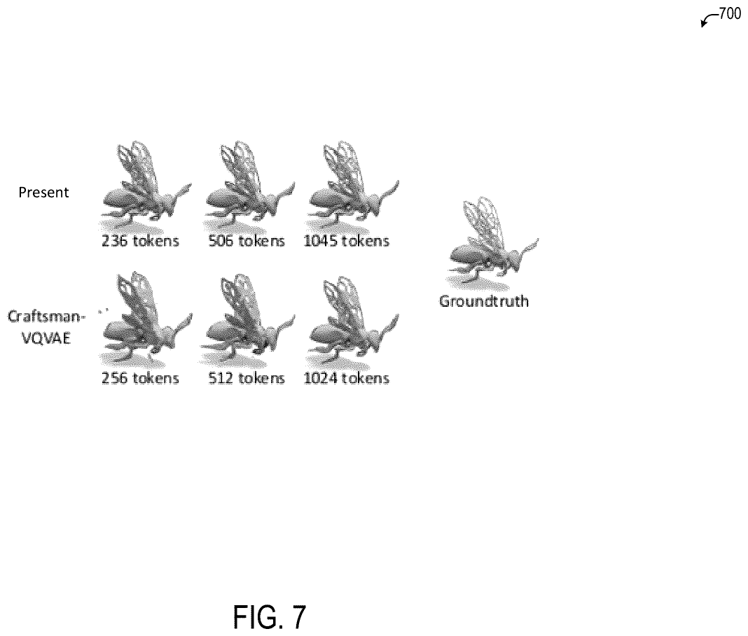

FIG. 7 depicts a visual comparison of an ablation study 700 on token length using various techniques, in accordance with some implementations.

Referring to FIG. 7, with a higher number of tokens, the present technique(s) achieve improved quality while consistently outperforming the baseline at a comparable token length. For example, the level of detail in the wings as well as other parts of the insect is higher for higher number of tokens.

The reconstruction fidelity of different representations is assessed, as shown below in Tables 1, 2, and 3. The present technique(s) are compared with Craftsman3D. The present technique(s) and Craftsman3D were trained under identical conditions, using both quantization for discrete tokenization and KL regularization for continuous latent space. Additionally, the present technique(s) are evaluated gained two other approaches, XCube and Octfusion. Due to computational resource constraints, publicly available pre-trained models for these two other approaches rather than retraining them using the present dataset.

Shape reconstruction quality is evaluated using volume Intersection over Union (IoU) and Chamfer Distance (CD) with 10K sampled surface points in Table 1 and Table 2, shown below. Note that XCube outperforms an Unsigned Distance Function (UDF), which cannot be evaluated with IoU metrics. The visual comparisons shown in FIG. 5 and FIG. 6 demonstrate the present technique(s) outperforms the other approaches.

TABLE 1
Quantitative analysis of shape reconstruction with discrete latent

| Method | Avg Token Cnt | IoU ↑ | CD (×10⁻³) ↓ |
|---|---|---|---|
| Craftsman-VQ | 256 | 84.1 | 2.31 |
| | 512 | 86.6 | 1.94 |
| | 768 | 87.7 | 1.88 |
| | 1024 | 88.1 | 1.80 |
| Present (OAT) | 148 | 84.7 | 2.19 |
| w/o A.S. | 607 | 88.3 | 1.85 |
| | 1726 | 90.1 | 1.37 |
| Present (OAT) | 266 | 86.7 | 1.94 |
| | 439 | 88.6 | 1.78 |
| | 625 | 89.7 | 1.53 |
| | 1284 | 90.5 | 1.27 |

As shown in Table 1, the present technique(s) (OAT) is/are compared against Craftsman-VQ and ablation without Adaptive Subdivision (A.S.). With comparable token counts, the present technique(s) outperform(s) both baselines.

TABLE 2
Quantitative analysis of shape reconstruction with continuous latent

| Method | Avg Latent Len | IoU ↑ | CD (×10⁻³) ↓ |
|---|---|---|---|
| Craftsman | 256 | 86.7 | 1.96 |
| | 512 | 89.2 | 1.83 |
| | 768 | 90.1 | 1.33 |
| | 1024 | 90.7 | 1.29 |
| Octfusion | 4096 | 88.9 | 1.87 |
| XCube | 4096 | — | 1.26 |
| Present (OAT-KL) | 148 | 87.4 | 1.89 |
| w/o A.S. | 607 | 90.3 | 1.29 |
| | 1726 | 92.0 | 1.01 |
| Present (OAT-KL) | 266 | 88.7 | 1.81 |
| | 439 | 90.6 | 1.29 |
| | 625 | 91.4 | 1.08 |
| | 1284 | 92.1 | 0.97 |

As shown in Table 2, the quantization is replaced with KL regularization to learn continuous latent, as mentioned above. The present technique(s) outperform all baselines with comparable or shorter latent code lengths.

The proposed adaptive subdivision in FIG. 5 is ablated. Without quadric-error-based adaptive subdivision, the octree representation subdivides to the deepest level unless empty, wasting tokens on simple objects of large volumetric occupancy (middle row). FIG. 4 shows reconstruction quality (IoU) versus latent size in both discrete and continuous scenarios, confirming the present technique(s) achieves improved quality at equivalent latent sizes and uses a smaller number of latent representations for comparable reconstruction quality. FIG. 7 further shows a qualitative comparison between the present technique(s) and the baseline in reconstruction quality with respect to the number of tokens used.

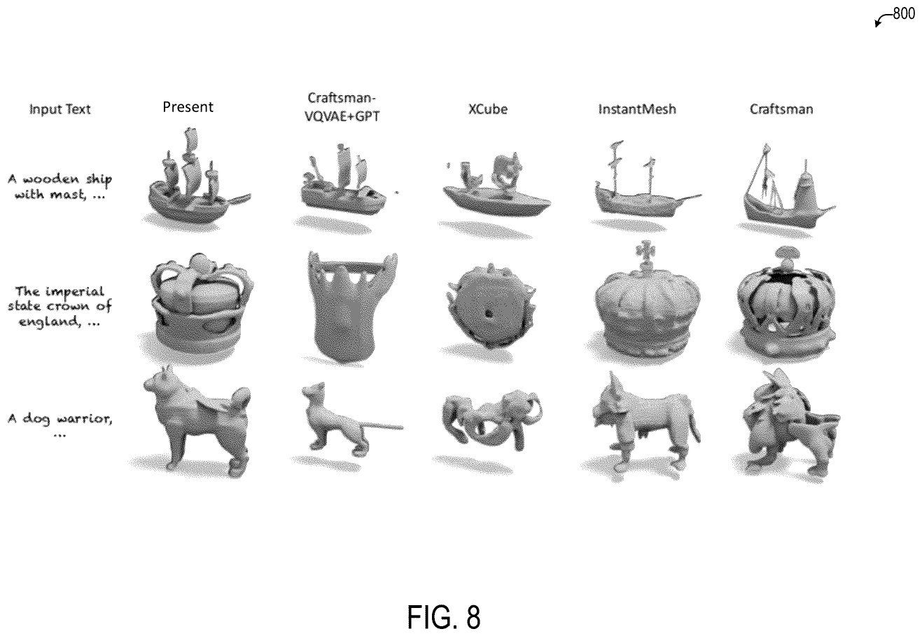

FIG. 8 depicts a visual comparison of shape generation results using various techniques, in accordance with some implementations. Referring to FIG. 8, a comparison of OctreeGPT with a GPT baseline trained on Craftsman-VQVAE, text-to-3D model XCube, and image-to-3D methods InstantMesh and Craftsman is shown. The present technique(s) provide smoother surfaces, finer details, and fewer artifacts than baseline approaches. For image-conditioned approaches, FLUX.1 is used to generate condition images from input text.

Table 3 shows the results of the quantitative analysis of shape generation results.

TABLE 3
Quantitative analysis of shape generation

| | | | CLIP- |
|---|---|---|---|
| Method | FID↓ | KID(×10⁻³)↓ | score↑ |
| Craftsman | 65.18 | 6.42 | 0.27 |
| InstantMesh | 67.93 | 7.23 | 0.31 |
| XCube | 132.56 | 9.83 | 0.23 |
| Craftsman-VQ + GPT | 85.10 | 7.49 | 0.26 |
| Present (OctreeGPT) | 56.88 | 5.79 | 0.34 |

Referring to Table 3, a comparison of OctreeGPT with a GPT baseline trained on Craftsman-VQVAE, text-to-3D model XCube, and image-to-3D methods InstantMesh and Craftsman is shown. The Frechet Inception Distance (FID), Kernel Inception Distance (KID), and CLIP-score are computed based on the renderings of generated shapes. The present technique(s) outperform(s) all baselines, showing higher quality and improved consistency with the input text.

Referring to FIG. 8, the OctreeGPT is trained on top of Octree-based Adaptive Shape Tokenization (OAT) using 439 tokens on average, and for comparison, a generative pre-trained transformer (GPT) model is trained on Craftsman-VQ with 512 tokens. XCube's pre-trained Objaverse model is included as a native text-to-3D baseline. A comparison against two image-to-3D methods, InstantMesh, and Craftsman, using FLUX.1 to generate condition image from input text is also performed.

The generation quality results shown in Table 3 are quantitatively evaluated by rendering generated shapes and computing FID and KID against ground-truth renderings. A CLIP-score is also provided to evaluate text-shape consistency. In addition to quantitative measures, qualitative comparisons are provided in FIG. 8. Overall, due to a more compact and representative latent space, the present OctreeGPT produces finer details with fewer artifacts compared to Craftsman-VQ with GPT, while also outperforming other 3D generation baselines in both geometric quality and prompt adherence.

As described above with reference to FIGS. 1-8, an Octree-based Adaptive Shape Tokenization (OAT), which is a framework that dynamically adjust latent representations according to shape complexity, is provided. OAT constructs an adaptive octree structure (or other tree structure) guided by a quadric-error-based subdivision criterion, allocating more tokens to complicated parts (with greater 3D detail) and objects while saving on simpler ones. The above-described experiments show that OAT can reduce token counts by 50% compared to fixed-size approaches, while maintaining comparable visual quality. Alternatively, with a similar number of tokens, OAT produces higher-quality shapes. Building on this tokenization, an Octree-based Autoregressive model, OctreeGPT, is provided that effectively leverages these variable sized representations.

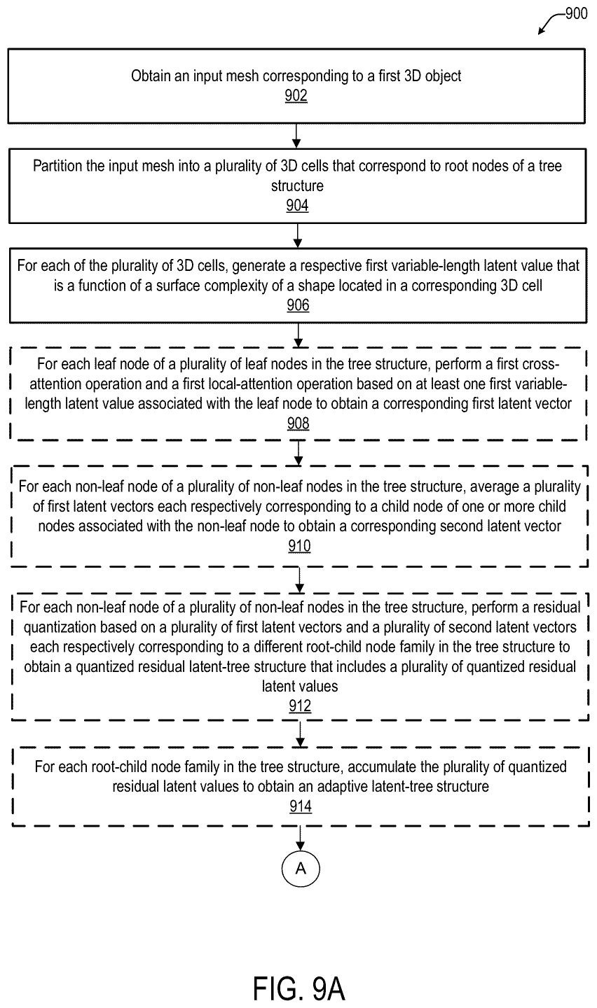

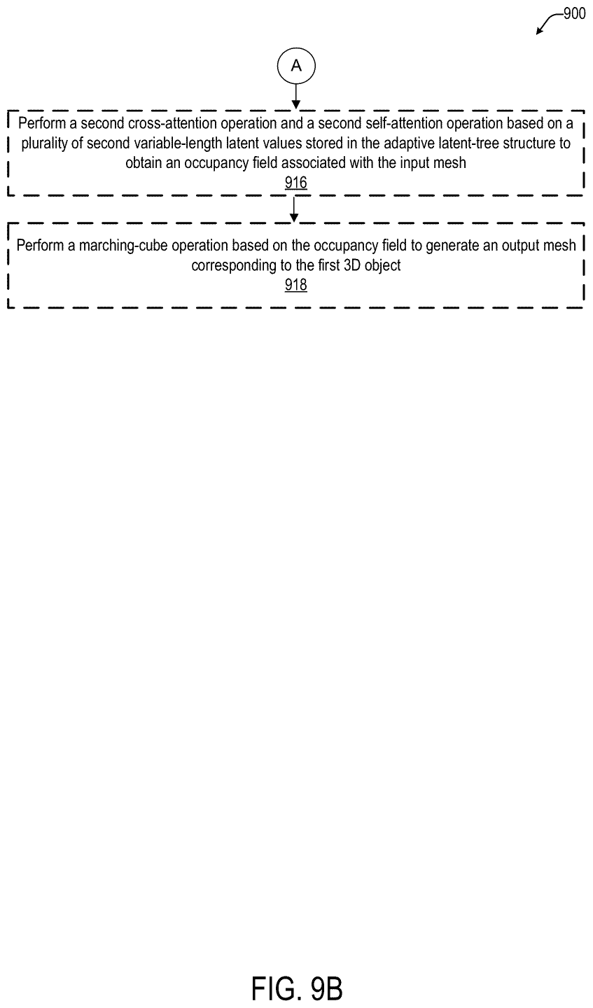

FIGS. 9A and 9B are a flowchart of an example method 900 of autoregressive shape generation, in accordance with some implementations.

In some implementations, method 900 can be implemented, for example, on an online virtual experience server 102 (e.g., by a virtual-experience coordinator) described with reference to FIG. 1. In some implementations, some or all of the method 900 can be implemented on one or more client devices 90 as shown in FIG. 1, on one or more developer devices 130, or on one or more online virtual experience server(s) 102, and/or on a combination of developer device(s), server device(s) and client device(s). In described examples, the implementing system includes one or more digital processors or processing circuitry (“processors”), and one or more storage devices (e.g., a data store 108 or other storage). In some implementations, different components of one or more servers and/or clients can perform different blocks or other parts of the method 900. In some examples, a first device is described as performing blocks of method 900. Some implementations can have one or more blocks of method 900 performed by one or more other devices (e.g., other client devices or server devices) that can send results or data to the first device.

In some implementations, method 900, or portions of the methods, can be initiated automatically by a system. In some implementations, the implementing system is a first device. For example, the method (or portions thereof) can be periodically performed, or performed based on one or more particular events or conditions, e.g., upon a user request and/or one or more other conditions occurring which can be specified in settings read by the methods. In FIG. 9, optional operations are indicated by dashed lines.

Referring to FIG. 9A, method 900 may begin at block 902. At block 902, an input mesh corresponding to a first 3D object is obtained.

Block 902 may be followed by block 904. At block 904, the input mesh is partitioned into a plurality of 3D cells. In some implementations, each of the plurality of 3D cells corresponds to a respective root node of a plurality of root nodes of a tree structure. In some implementations, the tree structure is an octree structure (with eight root nodes), a quadtree structure, or a k-dimensional tree structure. Block 904 may be followed by block 906.

At block 906, for each of the plurality of 3D cells, a respective first variable-length latent value that is a function of a surface complexity of a shape located in a corresponding 3D cell is generated.

In some implementations, for each of the plurality of 3D cells, generating the respective first variable-length latent value that is the function of the surface complexity of the shape located in the corresponding 3D cell may include, in response to a 3D cell of the plurality of 3D cells containing at least one surface point of the input mesh, computing a quadric-error metric associated with a local geometry corresponding to the at least one surface point included in the 3D cell. In some implementations, for each of the plurality of 3D cells, generating the respective first variable-length latent value that is the function of the surface complexity of the shape located in the corresponding 3D cell may include, in response to a 3D cell of the plurality of 3D cells containing at least one surface point of the input mesh, determining whether a complexity of the local geometry meets a complexity threshold based on the quadric-error metric. In some implementations, for each of the plurality of 3D cells, generating the respective first variable-length latent value that is the function of the surface complexity of the shape located in the corresponding 3D cell may include, in response to a 3D cell of the plurality of 3D cells containing at least one surface point of the input mesh, and in response to the complexity of the local geometry meeting the complexity threshold, recursively partitioning the 3D cell into a plurality of subdivisions that each respectively include a corresponding subset of the at least one surface point until a maximum partitioning depth has been reached to obtain the tree structure. In some implementations, each of the plurality of subdivisions correspond to a respective child node of a plurality of child nodes of the tree structure. In some implementations, for each of the plurality of 3D cells, generating the respective first variable-length latent value that is the function of the surface complexity of the shape located in the corresponding 3D cell may include, in response to a 3D cell of the plurality of 3D cells containing at least one surface point of the input mesh, generating the first variable-length latent value for the 3D cell based on the recursive partitioning.

In some implementations, for each of the plurality of 3D cells, generating the respective first variable-length latent value that is the function of the surface complexity of the shape located in the corresponding 3D cell includes determining whether the 3D cell contains the at least one surface point of the input mesh. Block 906 may be followed by block 908.

At block 908, for each leaf node of a plurality of leaf nodes in the tree structure, a first cross-attention operation and a first local-attention operation is performed based on at least one latent value associated with the leaf node to obtain a corresponding first latent vector. In some implementations, the plurality of leaf nodes correspond to bottom-most child nodes of the plurality of child nodes in the tree structure. Block 908 may be followed by block 910.

At block 910, for each non-leaf node of a plurality of non-leaf nodes in the tree structure, a plurality of first latent vectors each respectively corresponding to a child node of one or more child nodes associated with the non-leaf node are averaged to obtain a corresponding second latent vector. In some implementations, the plurality of non-leaf nodes include nodes in the tree structure other than the bottom-most child nodes.

Block 910 may be followed by block 912. At block 912, for each root-child node family in the tree structure, a residual quantization is performed based on a plurality of first latent vectors and a plurality of second latent vectors each respectively corresponding to a different root-child node family in the tree structure to obtain a quantized residual latent-tree structure that includes a plurality of quantized residual latent values.

Block 912 may be followed by block 914. At block 914, for each root-child node family in the tree structure, the plurality of quantized residual latent values are accumulated to obtain an adaptive latent-tree structure.

Referring to FIG. 9B, block 914 may be followed by block 916. At block 916, a second cross-attention operation and a second self-attention operation is performed based on a plurality of second variable-length latent values stored in the adaptive latent-tree structure to obtain an occupancy field associated with the input mesh. Block 916 may be followed by block 918.

At block 918, a marching cube operation is performed based on the occupancy field to generate an output mesh corresponding to the first 3D object.

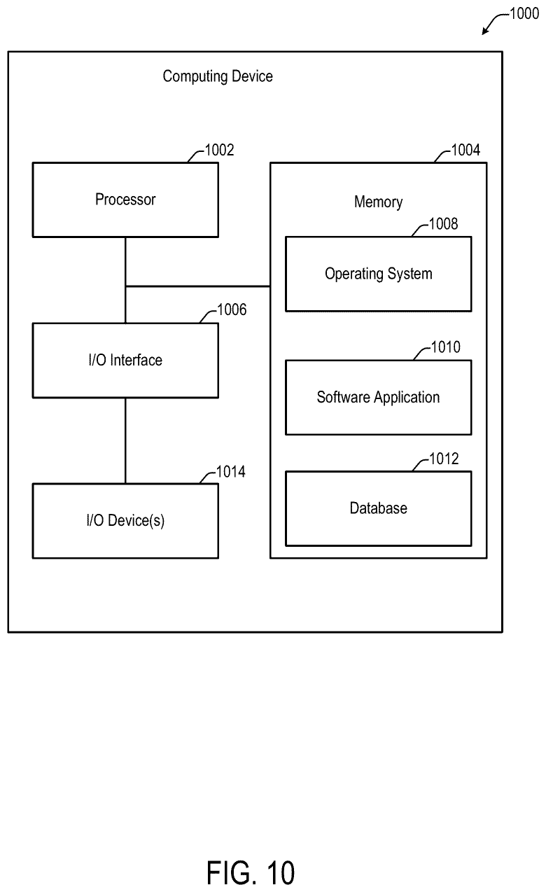

Hereinafter, a more detailed description of various computing devices that may be used to implement different devices and/or components illustrated in FIG. 1 is provided with reference to FIG. 10.

FIG. 10 is a block diagram of an example computing device 1000 which may be used to implement one or more features described herein, in accordance with some implementations. Computing device 1000 includes a hardware processor 1002, a memory 1004, and an input/output interface (I/O interface) 1006 all coupled by a bus. I/O interface 1006 may be coupled to one or more I/O devices 1014. Memory 1004 may store an operating system 1008, one or more software applications 1010, and a database 1012. Memory 1004 may store additional data and/or applications not shown. Computing device 1000 may be configured to perform one of the operations described above with reference to FIGS. 2 and 3.

In various implementations, computing device 1000 may be used to implement a computer device, (e.g., 102, 110 of FIG. 1), and perform appropriate operations as described herein. Computing device 1000 can be any suitable computer system, server, or other electronic or hardware device. For example, the computing device 1000 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 1000 includes a processor 1002, a memory 1004, input/output (I/O) interface 1006, and audio/video input/output devices 1014 (e.g., display screen, touchscreen, display goggles or glasses, audio speakers, headphones, microphone, etc.).

Processor 1002 can be one or more processors and/or processing circuits to execute program code and control basic operations of the device 1000. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1004 is typically provided in device 1000 for access by the processor 1002, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1002 and/or integrated therewith. Memory 1004 can store software operating on the server device 1000 by the processor 1002, including an operating system 1008, software application 1010, and associated database 1012. In some implementations, the software application 1010 can include instructions that enable processor 1002 to perform the functions described herein. Software application 1010 may include some or all of the functionality used to perform autoregressive shape generation. In some implementations, one or more portions of software application 1010 may be implemented in dedicated hardware such as an application-specific integrated circuit (ASIC), a programmable logic device (PLD), a field-programmable gate array (FPGA), a machine learning processor, etc. In some implementations, one or more portions of software application 1010 may be implemented in general purpose processors, such as a central processing unit (CPU) or a graphics processing unit (GPU). In various implementations, suitable combinations of dedicated and/or general-purpose processing hardware may be used to implement software application 1010.

For example, software application 1010 stored in memory 1004 can include instructions for performing autoregressive shape generation (e.g., as described with reference to FIGS. 9A and 9B). Any of software in memory 1004 can alternatively be stored on any other suitable storage location or computer-readable medium. In addition, memory 1004 (and/or other connected storage device(s)) can store instructions and data used in the features described herein. Memory 1004 and any other type of storage (magnetic disk, optical disk, magnetic tape, or other tangible media) can be considered “storage” or “storage devices.”

I/O interface 1006 can provide functions to enable interfacing the server device 1000 with other systems and devices. For example, network communication devices, storage devices (e.g., memory and/or data store 120), and input/output devices can communicate via interface 1006. In some implementations, the I/O interface can connect to interface devices including input devices (keyboard, pointing device, touchscreen, microphone, camera, scanner, etc.) and/or output devices (display device, speaker devices, printer, motor, etc.).

For ease of illustration, FIG. 10 shows one block for each of processor 1002, memory 1004, I/O interface 1006, operating system 1008, software application 1010, and database 1012. These blocks may represent one or more processors or processing circuitries, operating systems, memories, I/O interfaces, applications, and/or software modules. In other implementations, device 1000 may not have all of the components shown and/or may have other elements including other types of elements instead of, or in addition to, those shown herein. While the online virtual experience server 102 are described as performing operations as described in some implementations herein, any suitable component or combination of components of online virtual experience server 102, or similar system, or any suitable processor or processors associated with such a system, may perform the operations described.

A user device can also implement and/or be used with features described herein. Example user devices can be computer devices including some similar components as the device 1000, e.g., processor(s) 1002, memory 1004, and I/O interface 1006. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 1014, for example, can be connected to (or included in) the device 1000 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

In some implementations, some or all of the methods can be implemented on a system such as one or more client devices. In some implementations, one or more methods described herein can be implemented, for example, on a server system, and/or on both a server system and a client system. In some implementations, different components of one or more servers and/or clients can perform different blocks, operations, or other parts of the methods.

One or more methods described herein (e.g., method 900) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the live feedback data for output (e.g., for display). In another example, computations can be split between the mobile computing device and one or more server devices.

The present disclosure is directed towards, inter alia, providing an auto-regressive 3D generator to automatically create three-dimensional (3D) assets (e.g., one or more 3D objects for use in a virtual environment, 3D scenes comprising multiple objects, etc.) across different scales in response to text prompts and/or image prompts as inputs. For example, the inputs may be provided by a user or received from a program, e.g., via an application programming interface (API). This approach enables creation of unique and stylized 3D scenes without requiring in-depth technical expertise and/or training for content creators. The high-level pipeline includes two parts. One part is training a 3D Vector Quantized Variational Autoencoder (VQ-VAE) to perform 3D tokenization to transform 3D shapes into tokens. A second part is training an auto-regressive transformer to perform 3D token generation based on prompts. Once trained, the VQ-VAE and auto-regressive transformer can be deployed for 3D content generation.

The problem addressed herein is that creating 3D assets is a difficult task associated with time-consuming manual effort. At present, creators manually design object-level components and complicated world-level scenes. The cumbersome nature of this work leads to long time requirements for developers as well as high financial costs. The work involved in alternative approaches also creates a bottleneck when generating content in virtual games and/or environments.

To ameliorate the difficulty of creating 3D assets, the technical solution described herein provides an auto-regressive 3D generator that permits a user to create 3D assets quickly and easily based on text prompts and/or image prompts. By allowing for the use of such prompts, a user can generate 3D scenes with little training or difficulty. Such an approach may operate by training a 3D Vector Quantized Variational Autoencoder (VQ-VAE) to perform 3D tokenization of shapes and by training an auto-regressive transformer to perform 3D token generation. Once these models are trained, the prompts may be transformed into 3D tokens and the 3D tokens may be decoded into 3D shapes to form 3D assets.

Existing works on Vector Quantized Variational Autoencoders (VQ-VAEs) primarily focus on tokenizing 2D image data. The technical solution provided herein uses an advantageous approach to encode 3D shapes into discrete tokens and vice versa. In some implementations, a scalable, fully attentional model that works on any modality (such as a particular type of transformer) is adopted as the architecture of the autoencoder.

Operations to perform the 3D tokenization are as follows. For example, the 3D tokenizer is trained as follows, based on training meshes. For the training, mesh preparation is performed to ensure that training meshes are suitable for use to train a model. In another operation, point sampling is performed. This operation includes sampling a number of points (e.g., 4096 points) from the surface(s) of the training meshes. In another operation, encoding is performed. This operation includes feeding the sampled points into the encoder, which encodes the sampled points as continuous latents, which may be corresponding latents.

In another operation, quantization is performed. This operation includes quantizing the latents into tokens using a learnable codebook (e.g., a codebook that may be learned based on training). In another operation, decoding is performed. This operation includes, when decoding from tokens to shapes, using the tokens to index the codebook to retrieve latents, then passing these latents (e.g., the retrieved corresponding latents) through several self-attention blocks and a final cross-attention block and/or cross-attention layer to obtain an occupancy field. In another operation, mesh reconstruction is performed. This operation includes generating a reconstructed mesh by running marching cubes on the obtained occupancy field. After the training, the 3D tokenizer is trained to receive arbitrary 3D tokens and decode the tokens into associated 3D shapes.

The training process may include supervised learning. For example, the reconstructed 3D mesh may be compared to the corresponding training 3D mesh to determine a loss function. The loss function may then be used to adjust parameters of the encoder and the decoder (jointly training both) to reduce the value of the loss function. By using a large set of training meshes and training over multiple epochs, the 3D VQ-VAE is trained to reconstruct meshes that match the training 3D mesh. At this point, the “encoded tokens” can accurately represent an arbitrary 3D mesh in embedding space, providing high-dimensional mathematical representation of the 3D mesh and the decoder can take any arbitrary 3D token sequence and decode it to corresponding 3D shapes (mesh) accurately.

Once trained, the auto-regressive transformer can generate tokens that are representative of the prompt in embedding space (e.g., convert “generate a rabbit with tiny ears” to embedding space). The tokens are then fed to the decoder block of the 3D VQ-VAE which generates corresponding 3D shapes (one or more shapes that can be arranged as a mesh).

After encoding shapes into sequences of tokens (using the 3D tokenization techniques), a downstream auto-regressive transformer is trained to model the distribution of the 3D token sequences. Some implementations may include two variations: a multimodal large language model (LLM) and a Generative Image Transformer with masking, both of which can be conditioned on text prompts and image prompts by prepending the text tokens and/or image tokens before the 3D tokens during a training process, wherein the prepending places the text tokens and/or the image tokens before the output 3D tokens from the 3D VQ-VAE during modeling of distribution of the output 3D tokens in the respective token sequence. Such modeling allows the auto-regressive transformer to ascertain how various text prompts and image prompts should be associated with sequences of tokens. Hence, the trained auto-regressive transformer can take a prompt and produce an appropriate sequence of tokens to serve as the basis of 3D shapes corresponding to the prompt.

After training the 3D tokenizer and the auto-regressive transformer, the 3D tokenizer and the auto-regressive transformer are used to generate 3D assets based on input text or images, e.g., received as prompts. Specifically, the auto-regressive transformer is used to perform a token generation operation for token sequence generation. In the token generation operation, the transformer is used to generate 3D tokens auto-regressively (from the prompt as input).

The 3D tokenizer is used to perform shape reconstruction. In shape reconstruction, the tokens are decoded to 3D shapes using a decoder component of the 3D tokenizer. The resulting 3D shapes can serve as the basis of a generated 3D asset. For example, as discussed above, the decoding may yield an occupancy field. The occupancy field may be used to generate a reconstructed mesh by running marching cubes on the occupancy field.

The overall model (including the 3D tokenizer and the auto-regressive transformer) is capable of generating assets across different physical scales, including both objects and scenes. To generate large-scale scenes, the model follows the following operations. One example operation is chunking. In chunking, scenes are chunked into blocks and tokenized similarly to normal objects. Another example operation is scalable generation. In scalable generation, scene generation is expanded to an arbitrarily large scale (e.g., as large of a scale as is permitted by the available computing resources) by sliding the attention window during the auto-regressive task.

Implementations can include using either or both of a multimodal large language model (LLM) and a Generative Image Transformer when implementing the auto-regressive transformer. Some implementations may also include different variations of a 3D tokenizer, including techniques for sparse representation, grid sampling, and additional techniques, other than randomly sampled point clouds.

In summary, the auto-regressive 3D generator provides a scalable and efficient solution to generate high-quality 3D assets, addressing the labor-intensive nature of traditional 3D modeling and expanding the creative possibilities available to content creators.

The solutions discussed herein can be integrated into a platform to build and publish games in a virtual environment, enabling developers to easily create 3D assets. This integration streamlines the asset creation process, allowing for rapid prototyping and development of 3D games and experiences.

The solutions discussed herein can also serve as the basis of a model for various downstream tasks in research and artistic communities. Researchers can explore new methodologies based on the foundation models in 3D generation, while artists can use the tool to quickly generate assets for their projects, pushing the boundaries of technology and digital art.

Some implementations include an auto-regressive 3D generator to facilitate easy creation of 3D assets based on text and/or image prompts. Preparing the generator includes training a 3D Vector Quantized Variational Autoencoder (VQ-VAE) to perform 3D tokenization to establish how to associate 3D shapes with sequences of tokens. The preparation also includes training an auto-regressive transformer to model distributions of 3D token sequences in association with various prompts (e.g., text prompts and/or image prompts).

Once these models are trained, one or more prompts (e.g., text prompts and/or image prompts) may be used as the basis of generating tokens and the generated tokens may be decoded to reconstruct shapes. Such shapes may serve as the basis of reconstructing newly generated 3D assets. The trained models may also be used to generate large-scale scenes, using approaches such as chunking and scalable generation. By using these techniques, it becomes much easier to generate 3D assets and scenes.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method for autoregressive shape generation, comprising:
obtaining, by a processor, an input mesh corresponding to a three-dimensional (3D) object;
partitioning, by the processor, the input mesh into a plurality of 3D cells, each of the plurality of 3D cells corresponding to a respective root node of a plurality of root nodes of a tree structure; and
for each of the plurality of 3D cells, generating, by the processor, a respective first variable-length latent value that is a function of a surface complexity of a shape located in a corresponding 3D cell.

2. The computer-implemented method of claim 1, wherein, for each of the plurality of 3D cells, generating the respective first variable-length latent value that is the function of the surface complexity of the shape located in the corresponding 3D cell comprises:
in response to a 3D cell of the plurality of 3D cells containing at least one surface point of the input mesh,
computing, by the processor, a quadric-error metric associated with a local geometry corresponding to the at least one surface point included in the 3D cell;
determining, by the processor, whether a complexity of the local geometry meets a complexity threshold based on the quadric-error metric;
in response to the complexity of the local geometry meeting the complexity threshold, recursively partitioning, by the processor, the 3D cell into a plurality of subdivisions that each respectively include a corresponding subset of the at least one surface point until a maximum partitioning depth has been reached to obtain the tree structure, each of the plurality of subdivisions corresponding to a respective child node of a plurality of child nodes of the tree structure; and
generating, by the processor, the first variable-length latent value for the 3D cell based on the recursive partitioning.

3. The computer-implemented method of claim 2, wherein, for each of the plurality of 3D cells, generating the respective first variable-length latent value that is the function of the surface complexity of the shape located in the corresponding 3D cell comprises determining, by the processor, whether the 3D cell contains the at least one surface point of the input mesh.

4. The computer-implemented method of claim 2, further comprising:
for each leaf node of a plurality of leaf nodes in the tree structure, performing, by the processor, a first cross-attention operation and a first local-attention operation based on at least one first variable-length latent value associated with the leaf node to obtain a corresponding first latent vector, the plurality of leaf nodes corresponding to bottom-most child nodes of the plurality of child nodes in the tree structure;
for each non-leaf node of a plurality of non-leaf nodes in the tree structure, averaging, by the processor, a plurality of first latent vectors each respectively corresponding to a child node of one or more child nodes associated with the non-leaf node to obtain a corresponding second latent vector, the plurality of non-leaf nodes including nodes in the tree structure other than the bottom-most child nodes; and
for each root-child node family in the tree structure, performing, by the processor, a residual quantization based on a plurality of first latent vectors and a plurality of second latent vectors each respectively corresponding to a different root-child node family in the tree structure to obtain a quantized residual latent-tree structure that includes a plurality of quantized residual latent values.

5. The computer-implemented method of claim 4, further comprising:
for each root-child node family in the tree structure, accumulating, by the processor, the plurality of quantized residual latent values to obtain an adaptive latent-tree structure.

6. The computer-implemented method of claim 5, further comprising:
performing, by the processor, a second cross-attention operation and a second self-attention operation based on a plurality of second variable-length latent values stored in the adaptive latent-tree structure to obtain an occupancy field associated with the input mesh.

7. The computer-implemented method of claim 6, further comprising:
performing, by the processor, a marching-cube operation based on the occupancy field to generate an output mesh corresponding to the 3D object.

8. The computer-implemented method of claim 1, wherein the tree structure is an octree structure, a quadtree structure, or a k-dimensional tree structure.

9. A non-transitory computer-readable medium with instructions stored thereon that, when executed by one or more hardware processors, cause the one or more hardware processors to perform operations comprising:
obtaining an input mesh corresponding to a three-dimensional (3D) object;
partitioning the input mesh into a plurality of 3D cells, each of the plurality of 3D cells corresponding to a respective root node of a plurality of root nodes of a tree structure; and
for each of the plurality of 3D cells, generating a respective first variable-length latent value that is a function of a surface complexity of a shape located in a corresponding 3D cell.

10. The non-transitory computer-readable medium of claim 9, wherein, for each of the plurality of 3D cells, generating the respective first variable-length latent value that is the function of the surface complexity of the shape located in the corresponding 3D cell comprises:
in response to a 3D cell of the plurality of 3D cells containing at least one surface point of the input mesh,
computing a quadric-error metric associated with a local geometry corresponding to the at least one surface point included in the 3D cell;
determining whether a complexity of the local geometry meets a complexity threshold based on the quadric-error metric;
in response to the complexity of the local geometry meeting the complexity threshold, recursively partitioning the 3D cell into a plurality of subdivisions that each respectively include a corresponding subset of the at least one surface point until a maximum partitioning depth has been reached to obtain the tree structure, each of the plurality of subdivisions corresponding to a respective child node of a plurality of child nodes of the tree structure; and
generating the first variable-length latent value for the 3D cell based on the recursive partitioning.

11. The non-transitory computer-readable medium of claim 10, wherein, for each of the plurality of 3D cells, generating the respective first variable-length latent value that is the function of the surface complexity of the shape located in the corresponding 3D cell comprises determining whether the 3D cell contains the at least one surface point of the input mesh.

12. The non-transitory computer-readable medium of claim 10, the operations further comprising:
for each leaf node of a plurality of leaf nodes in the tree structure, performing a first cross-attention operation and a first local-attention operation based on at least one first variable-length latent value associated with the leaf node to obtain a corresponding first latent vector, the plurality of leaf nodes corresponding to bottom-most child nodes of the plurality of child nodes in the tree structure;
for each non-leaf node of a plurality of non-leaf nodes in the tree structure, averaging a plurality of first latent vectors each respectively corresponding to a child node of one or more child nodes associated with the non-leaf node to obtain a corresponding second latent vector, the plurality of non-leaf nodes including nodes in the tree structure other than the bottom-most child nodes; and
for each root-child node family in the tree structure, performing a residual quantization based on a plurality of first latent vectors and a plurality of second latent vectors each respectively corresponding to a different root-child node family in the tree structure to obtain a quantized residual latent-tree structure that includes a plurality of quantized residual latent values.

13. The non-transitory computer-readable medium of claim 12, the operations further comprising:
for each root-child node family in the tree structure, accumulating the plurality of quantized residual latent values to obtain an adaptive latent-tree structure.

14. The non-transitory computer-readable medium of claim 13, the operations further comprising:
performing a second cross-attention operation and a second self-attention operation based on a plurality of second variable-length latent values stored in the adaptive latent-tree structure to obtain an occupancy field associated with the input mesh; and
performing a marching-cube operation based on the occupancy field to generate an output mesh corresponding to the 3D object.

15. A computing device, comprising:
one or more hardware processors; and
a non-transitory computer readable medium coupled to the one or more hardware processors, with instructions stored thereon, that when executed by the one or more hardware processors, cause the one or more hardware processors to perform operations comprising:
obtaining an input mesh corresponding to a three-dimensional (3D) object;
partitioning the input mesh into a plurality of 3D cells, each of the plurality of 3D cells corresponding to a respective root node of a plurality of root nodes of a tree structure; and
for each of the plurality of 3D cells, generating a respective first variable-length latent value that is a function of a surface complexity of a shape located in a corresponding 3D cell.

16. The computing device of claim 15, wherein, for each of the plurality of 3D cells, generating the respective first variable-length latent value that is the function of the surface complexity of the shape located in the corresponding 3D cell comprises:
in response to a 3D cell of the plurality of 3D cells containing at least one surface point of the input mesh,
computing a quadric-error metric associated with a local geometry corresponding to the at least one surface point included in the 3D cell;
determining whether a complexity of the local geometry meets a complexity threshold based on the quadric-error metric;
in response to the complexity of the local geometry meeting the complexity threshold, recursively partitioning the 3D cell into a plurality of subdivisions that each respectively include a corresponding subset of the at least one surface point until a maximum partitioning depth has been reached to obtain the tree structure, each of the plurality of subdivisions corresponding to a respective child node of a plurality of child nodes of the tree structure; and
generating the first variable-length latent value for the 3D cell based on the recursive partitioning.

17. The computing device of claim 16, wherein, for each of the plurality of 3D cells, generating the respective first variable-length latent value that is the function of the surface complexity of the shape located in the corresponding 3D cell comprises determining whether the 3D cell contains the at least one surface point of the input mesh.

18. The computing device of claim 16, the operations further comprising:
for each leaf node of a plurality of leaf nodes in the tree structure, performing a first cross-attention operation and a first local-attention operation based on at least one first variable-length latent value associated with the leaf node to obtain a corresponding first latent vector, the plurality of leaf nodes corresponding to bottom-most child nodes of the plurality of child nodes in the tree structure;
for each non-leaf node of a plurality of non-leaf nodes in the tree structure, averaging a plurality of first latent vectors each respectively corresponding to a child node of one or more child nodes associated with the non-leaf node to obtain a corresponding second latent vector, the plurality of non-leaf nodes including nodes in the tree structure other than the bottom-most child nodes; and
for each root-child node family in the tree structure, performing a residual quantization based on a plurality of first latent vectors and a plurality of second latent vectors each respectively corresponding to a different root-child node family in the tree structure to obtain a quantized residual latent-tree structure that includes a plurality of quantized residual latent values.

19. The computing device of claim 18, the operations further comprising:
for each root-child node family in the tree structure, accumulating the plurality of quantized residual latent values to obtain an adaptive latent-tree structure.

20. The computing device of claim 19, the operations further comprising:
performing a second cross-attention operation and a second self-attention operation based on a plurality of second variable-length latent values stored in the adaptive latent-tree structure to obtain an occupancy field associated with the input mesh; and
performing a marching-cube operation based on the occupancy field to generate an output mesh corresponding to the 3D object.
